(19) United States
(12) Patent Application Publication
(10) Pub. No.: US 2002/0071213 A1
(43) Pub. Date: Jun. 13, 2002

(54) Transport securing element for data storage cartridges, stack of data storage cartridges with transport securing elements and related method

(75) Inventors: Klaus Schoettle, Strasbourg (FR); Istvan Gergely, Schutterwald (DE)

Correspondence Address: GREENBLUM & BERNSTEIN, P.L.C., 1941 ROLAND CLARKE PLACE, RESTON, VA, 20191, US

(73) Assignee: EMTEC MAGNETICS, GmbH of Ludwigshafen (DE)

(21) Appl. No.: 09/981,711

(22) Filed: Oct. 19, 2001

(30) Foreign Application Priority Data
Dec. 13, 2000 (DE) 200 21 132.3

(51) Int. Cl. G11B 23/02

(52) U.S. Cl. 360/132

(57) ABSTRACT

Combination of at least one transport securing element and at least one data storage cartridge, the data storage cartridge including a housing which has at least one access opening. The housing encloses at least one tape reel and at least one biased reel brake mechanism. The at least one reel brake mechanism is adapted to prevent movement of the at least one tape reel. The transport securing element is dimensioned to slide in and out of the at least one access opening and is adapted to move the tape reel from a first position to a second position. The at least one transport securing element is free to slide out of the at least one access opening under a biasing force exerted by the reel brake mechanism when a force opposing the biasing force is removed. A method for forming a package is provided in which the at least one cartridge is wrapped.

### CROSS-REFERENCE TO RELATED APPLICATIONS

The present application claims priority under 35 U.S.C. § 119 of German Patent Application No. 200 21 132.3, filed on Dec. 13, 2000, the disclosure of which is expressly incorporated by reference herein in its entirety.

### BACKGROUND OF THE INVENTION

1. Field of the Invention

The invention relates to a transport securing element which is used with data storage cartridges. The cartridges may be of the type having data recording medium in tape form. The invention also relates to a stack of data storage cartridges which utilizes the transport securing elements as well as a method of storing the data storage cartridges using the transport securing elements.

2. Description of Related Art

Data storage cartridges of this type are known for example by the names MTC, DLT and Ultrium and comprise at least: a cartridge housing having an upper housing half and a lower housing half with a tape reel disposed with the housing halves. The housing halves may be releasably or non-releasably connected together to enclose the reel. The upper housing half has cover and side walls, while the lower housing half has a base and side walls. The base of the lower housing half has at least one circular access opening. The tape reel is rotatably mounted in the cartridge housing and is biased to one side with a spring inside the cartridge. The tape reel comprises a lower reel flange, upper reel flange and a hub portion. The data recording medium in tape form is wound up on the hub and has a free end to which a tape guiding element is attached. The tape guiding element aids in guiding the magnetic tape to the take-up reel so that it can be wound up. A part of the tape reel hub protrudes into the access opening and this part has means for coupling the tape reel to the drive hub on an equipment side. Finally, a reel brake is utilized within the cartridge for preventing the tape reel from turning or rotating when the drive hub of the equipment side is not engaged with the tape reel, i.e, when the cartridge is removed from the equipment.

Among the means which are utilized for coupling the tape reel to the drive hub of the equipment are, for example, driving serrations, which are generally located in the edge region of an end face of the tape reel hub. The serrations may be in the form of disk-shaped metal plates which are formed in the end face itself, and may also have in its center, an annular aperture which serves for centering the tape reel on the drive hub, on the equipment side, and also for releasing the braking serration.

Various types of reel brakes are known to a person skilled in the art. For example, the reel brake utilized in the MTC or Magstar cartridge comprises a braking part and a spring. This type of cartridge is shown, by way of example, in the description and in the drawings herein.

The brake reel normally assumes two positions within the cartridge housing. In a first end position or rest position of the tape reel, the cartridge is not coupled to any equipment, i.e., the cartridge is outside the drive. In this case, the tape reel, and particularly its lower reel flange, bears or is forced against an inner side of the housing base under a spring force which acts on one side of the tape reel. However, when the cartridge is loaded into the drive, i.e., installed onto equipment, the reel brake is released by engagement with a drive hub of the drive and the tape reel is raised or moved away from the inner side of the housing base. Thus, the reel within the cartridge has a first un-installed position and a second installed position, i.e., a position wherein the tape reel is free to rotate and operate with equipment because the spring force has been overcome.

During use or installation of the cartridge in the drive no forces, which may lead to damage of the tape reel or the data recording medium in tape form wound up on it, normally act on the cartridge.

However, the situation is different when the cartridge is outside or unmounted to the drive. This is particularly true when the cartridge is being transported from the manufacturer's or dealer's premises to the end user. The forces which occur during this transportation time may be due to vibrations and improper handling. These forces may be so great that the force exerted by the spring of the reel brake on the tape reel is overcome such that the tape reel is allowed to be moved out of its rest position within the housing. When this happens, it is possible for the tape reel to tilt about its axis of rotation, as well as for the flanges of the tape reel to hit or contact the inner side of the housing cover and/or housing base. This contact almost always results in damage to the relatively thin flanges of the tape reel, i.e., they may be deformed to the extent that a clear width between the flanges, in the region of the reel which remains unwound, changes, and consequently the edges of the data recording medium tape become damaged. As storage capacities have become ever greater, the data recording media, in tape form, becomes thinner and thinner and consequently more and more sensitive to damage. In extreme cases, such damage to these thin tapes has the consequence that the edge tracks or servo tracks of the tape can no longer be read, which can render the cartridge unusable.

U.S. Pat. No. 5,826,811 describes an insertable plug which is used to prevent the reel from moving within a cartridge. The device is in the form of a reel securing element and is substantially a cap-shaped plug made of plastic. The plug has resilient lip portions arranged on an outer circumference. This plug is utilized by being pushed into the access opening of the lower part of the housing. This causes the tape reel to be pressed against the upper part of the housing. The lip portions of the plug then engage an annular elevation which is provided on the inner side of the lower part of the housing adjacent to the access opening. This action consequently fixes the tape reel within the cartridge. Finally, the plug can be removed from the cartridge by way of a tab or grip which may enter into the plug, so that the cartridge may be ready for use in a drive.

However, there is a disadvantage to this arrangement, i.e., when the lip portions engage with the lower part of the housing, abrasion occurs, which causes dropouts. This is unacceptable for high-grade data storage systems. Furthermore, removal of the plug is awkward because it has to be removed by hand, or requires the use of a suitable implement.

### SUMMARY OF THE INVENTION

The present invention lacks these disadvantages and provides for a transport securing element which does not cause abrasion during insertion into and removal from the cartridge housing, and which can be removed without the aid of implements. Accordingly, the transport securing element is simple in design so as to slide automatically out of the access opening. The invention provides for forming a stack of data storage cartridges which use one or more transport securing elements. Finally, the invention provides for a method of securing the stack of data storage cartridges for transport, wherein one or more transport securing elements are utilized which can be slid automatically out of each cartridge after removal of a wrapping from around the stack.

The invention provides for a combination of at least one transport securing element and at least one data storage cartridge. The data storage cartridge includes a housing which has at least one access opening. The housing encloses at least one tape reel and at least one biased reel brake mechanism. The at least one reel brake mechanism is adapted to prevent movement of the at least one tape reel. The transport securing element is dimensioned to slide in and out of the at least one access opening and is adapted to move the tape reel from a first position to a second position. The at least one transport securing element is free to slide out of the at least one access opening under a biasing force exerted by the reel brake mechanism when a force opposing the biasing force is removed.

The at least one transport securing element may be free to move in and out of the at least one access opening without being non-movably retained by the housing. The housing may comprise at least two parts which are one of releasably and non-releasably attached to one another. The at least one transport securing element may be one of substantially disk-shaped and substantially circular. The at least one transport securing element may comprise at least two legs. The at least one access opening may be substantially circular. The at least one tape reel may comprise a reel hub portion and at least two flange portions. The at least one tape reel may comprise a portion which at least partially protrudes into the at least one access opening. The second position may comprise a position wherein the at least one tape reel is positioned against a side of the housing which is opposite to a side of the housing which has the at least one access opening. The tape reel may comprise a hub which protrudes into the at least one access opening, the hub including a mechanism for coupling the at least one tape reel to a drive hub. The at least one tape reel may be movable when the at least one reel brake mechanism is disengaged from the at least one tape reel. The at least one transport securing element may be substantially in the shape of a hollow-cylinder.

The at least one transport securing element may comprise a thickness, which when added to a thickness of the at least one tape reel, is substantially approximately equal to a width of a space within the housing plus a thickness of a side wall which contains the at least one access opening.

The at least one transport securing element may comprise a thickness, which when added to a thickness of the at least one tape reel measured on one side of the tape reel and a flange on another side of the tape reel, is substantially approximately equal to a width of a space within the housing plus a thickness of a side wall which contains the at least one access opening.

The at least one transport securing element may comprise a thickness, which when added to a thickness of the at least one tape reel measured on one side of the tape reel and a flange on another side of the tape reel, is substantially approximately equal to twice a width of a space within the housing plus a thickness of a side wall which contains the at least one access opening.

The at least one transport securing element may comprise a thickness, which when added to a thickness of the at least one tape reel, is substantially approximately equal to twice a width of a space within the housing plus a thickness of a side wall which contains the at least one access opening.

The at least one transport securing element may comprise at least one of a circular elevation and an annular elevation. The at least one of the circular or annular elevations may be arranged on a side of the transport securing element which engages the at least one tape reel. At least one of the circular or annular elevations may be arranged on a side of the transport securing element which is opposite a side that engages the at least one tape reel. At least another of the circular or annular elevations may be arranged on a side of the transport securing element which is opposite a side that engages the at least one tape reel.

The invention also provides for a combination of at least one transport securing element and at least one data storage cartridge. The data storage cartridge comprises a housing which includes at least one access opening. The housing encloses at least one tape reel and at least one biased reel brake mechanism. The at least one reel brake mechanism is adapted to prevent movement of the at least one tape reel. The transport securing element is dimensioned to slide in and out of the at least one access opening and is adapted to move the tape reel from a first position to a second position. The at least one transport securing element is free to slide out of the at least one access opening under a biasing force exerted by the reel brake mechanism when a force opposing the biasing force is removed. The at least one cartridge is wrapped with a material.

The at least one cartridge may comprise at least two cartridges and at least two transport securing elements, each of the transport securing elements may be free to slide out of the at least one access opening under a biasing force exerted by the reel brake mechanism when a force opposing the biasing force is removed. The at least one cartridge may comprise at least two cartridges arranged with their at least one access openings facing one another, the at least one transport securing element may be free to slide out of both access openings of adjacent cartridges under a biasing force exerted by the reel brake mechanisms when a force opposing the biasing force is removed. The at least one cartridge may comprise a stack of cartridges. The combination may further comprise a plate for preventing the removal of the at least one of the transport securing element. The wrapping may cover the plate and the at least one cartridge.

The invention further provides for a method combining at least one transport securing element and at least one data storage cartridge, in which the method includes providing the data storage cartridge comprising a housing which includes at least one access opening, the housing enclosing at least one tape reel and at least one biased reel brake mechanism, wherein the at least one reel brake mechanism is adapted to prevent movement of the at least one tape reel, installing the at least one transport securing element into the at least one access opening, the transport securing element being dimensioned to slide in and out of the at least one access opening and being adapted to move the tape reel from a first position to a second position, wherein the at least one transport securing element is free to slide out of the at least one access opening under a biasing force exerted by the reel brake mechanism when a force opposing the biasing force is removed, and wrapping the at least one cartridge with a material.

The at least one cartridge may comprise at least two cartridges and at least two transport securing elements, each of the transport securing elements being free to slide out of the at least one access opening under a biasing force exerted by the reel brake mechanism when a force opposing the biasing force is removed.

The at least one cartridge may comprise at least two cartridges arranged with their at least one access openings facing one another, the at least one transport securing element being free to slide out of both access openings of adjacent cartridges under a biasing force exerted by the reel brake mechanisms when a force opposing the biasing force is removed.

The method may further comprise forming a stack of cartridges. The method may further comprise installing a plate at one end of the stack for preventing the removal of the at least one of the transport securing element. The wrapping may cover the plate and the at least one cartridge.

### BRIEF DESCRIPTION OF THE DRAWINGS

The present invention is further described in the detailed description which follows, in reference to the noted plurality of drawings by way of non-limiting examples of embodiments of the present invention, in which like reference numerals represent similar parts throughout the several views of the drawings, and wherein:

FIG. 1a shows a section through a schematically represented data storage cartridge. The tape reel is located in a lower non-use position and a first embodiment of the transport securing element is shown below the cartridge;

FIG. 1b shows a section through the data storage cartridge of FIG. 1a, with the transport securing element being inserted into the cartridge;

FIG. 2a shows a section through a similar data storage cartridge, again with the tape reel being located in a lower position. A second embodiment of the transport securing element is shown below the cartridge;

FIG. 2b shows a section through a data storage cartridge of FIG. 2a, with the transport securing element inserted into the cartridge;

FIG. 3a shows a section through another similar data storage cartridge, with the tape reel again being located in a lower position. A third embodiment of the transport securing element is shown below the cartridge;

FIG. 3b shows a section through a data storage cartridge of FIG. 3a, with the transport securing element inserted into the cartridge;

FIG. 4a shows a section through still another similar data storage cartridge, with the tape reel again being located in a lower position. A fourth embodiment of the transport securing element is shown below the cartridge;

FIG. 4b shows a section through a data storage cartridge of FIG. 4a, with the transport securing element inserted into the cartridge;

FIG. 5a shows an isometric view of one particular embodiment of transport securing element;

FIG. 5b shows another isometric view of another particular embodiment of transport securing element;

FIG. 5c shows an isometric view of still another particular embodiment of transport securing element;

FIG. 6 shows a stack of data storage cartridges which utilizes many transport securing elements, with each cartridge in the stack having its own transport securing element inserted therein;

FIG. 7 shows a stack of data storage cartridges which utilizes many transport securing elements, with adjacent cartridges in the stack sharing a transport securing element inserted therein; and

FIGS. 8a-c show various embodiments of transport securing elements of the type which can be used in the stack shown in FIG. 7. These transport securing elements are designed to be inserted into each of the adjacent cartridges shown in FIG. 7.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

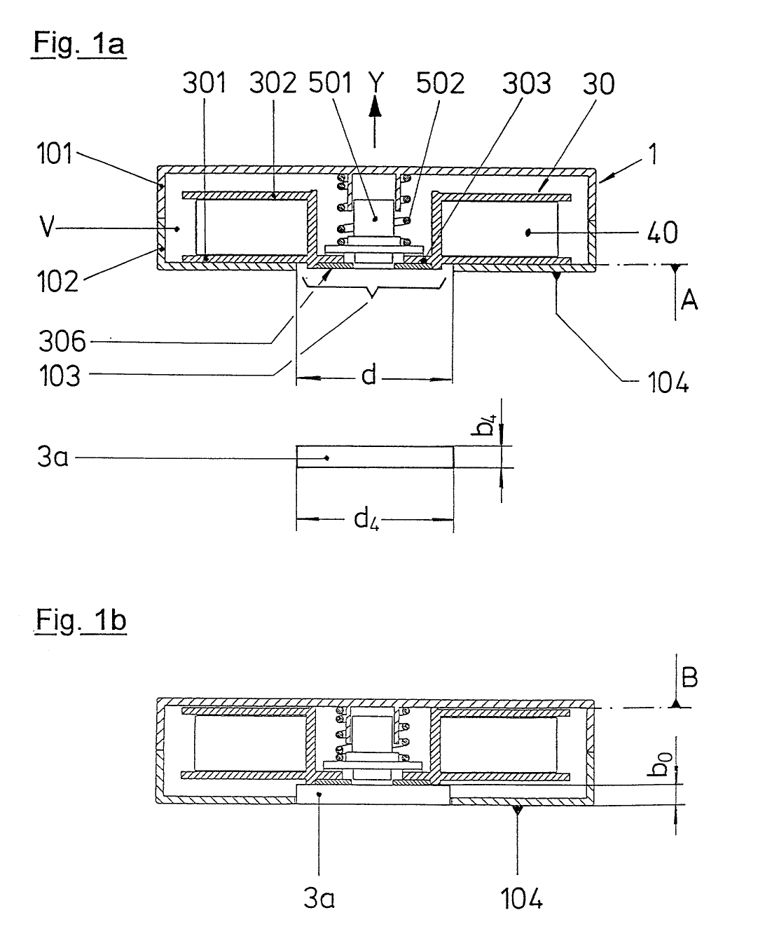

FIG. 1 shows a first embodiment of a transport securing element 3a which can be inserted into a circular access opening 103 of the lower housing part 102 of the cartridge 1. The cartridge 1 is formed of a two part housing in which an upper housing part 101 is connected to a lower housing part 102. The two housing parts 101, 102 define an interior space V, which accommodates a tape reel 30, a spring 502 and a reel brake 501. The tape reel 30 has an upper flange 302 and a lower flange 301 which define a space for holding the wound up tape 40, i.e., data storage medium. The tape reel also has a hub portion 303 and an end face portion 306.

The transport securing element 3a is a substantially disk-shaped element which has an outside diameter d₄ that is approximately slightly smaller than the diameter d of the circular access opening 103 in the lower housing half 102. This provides for a clearance which allows the transport securing element 3a to be easily inserted into the circular access opening 103. A thickness b₄ of the transport securing element 3a is designed to be approximately substantially equal to the distance b₀ between an end face 306 of the tape reel hub 303, which protrudes through the access opening 103, and an upper abutting position B of the upper reel flange 302 disposed against the upper housing half 101. The distances B and b₀ added together substantially correspond to a width of the interior space V of the cartridge 1 plus a thickness of the lower housing, or a distance from the bottom of the interior space V to the outer surface 104. As can be seen from FIGS. 1a and 1b, the distance b₀ substantially corresponds to the thickness b₄ so that the upper flange 302 of the reel 30 is forced to contact the inner surface of the upper housing part 101, as shown in FIG. 1b. It is preferred that the thickness b₄ be slightly greater than the distance b₀ so that the upper flange 302 can engage the inner surface of the upper housing part 101.

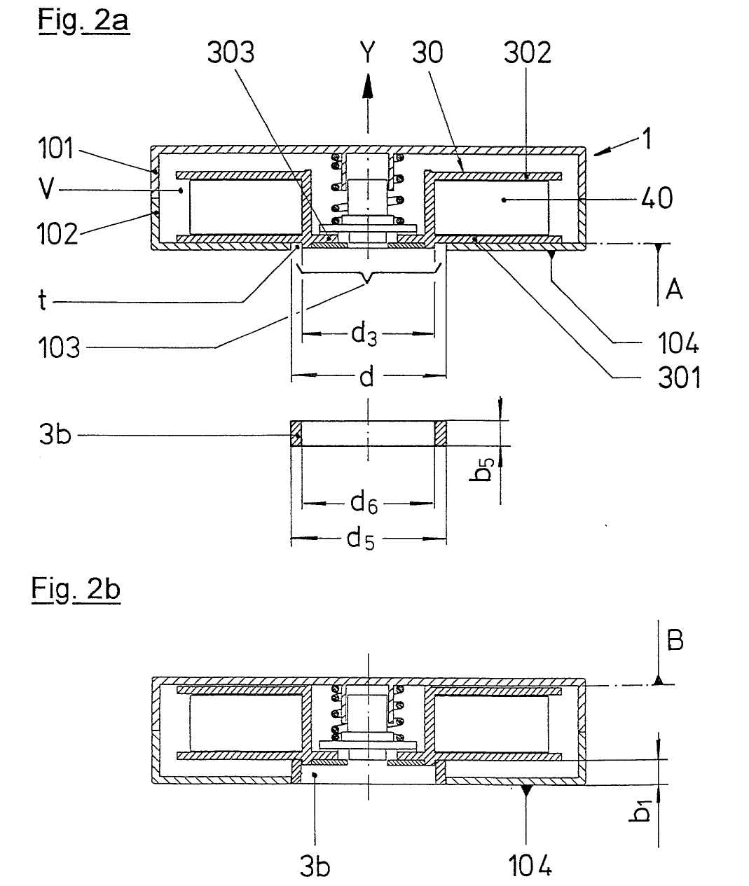

FIGS. 2a and 2b show another embodiment the transport securing element 3b which can be inserted into the circular access opening 103 of the lower housing part 102.

According to this embodiment, the diameter d₃ of the part of the tape reel hub 303 that protrudes into the access opening 103 is significantly smaller than the diameter “d” of the access opening 103. As a result, an annular space, distance or gap “t” is produced between an outer circumferential surface of the part of the tape reel hub 303 protruding into the opening 103 and an inner circumferential surface of the access opening 103.

The transport securing element 3b of this embodiment is formed as a substantially hollow-cylindrical design in which an outside diameter d₅ is approximately slightly smaller than the diameter “d” of the circular access opening 103. An inside diameter d₆ is made slightly larger than the diameter d₃ of the lower reel flange 301 so as to provide clearance for the transport securing element 3b to be easily inserted into the annular space “t”. The thickness b₅ of the transport securing element 3b is approximately substantially determined by accounting for the distance b₁ between the lower reel flange 301 and the upper abutting position B of the tape reel 30 when the tape reel is positioned against the upper housing half 101 in the interior space V, and the outer surface facing away from the interior space of the lower housing half 102. It is preferred that the thickness b₅ be slightly greater than the distance b₁ so that the upper flange 302 can engage the inner surface of the upper housing part 101.

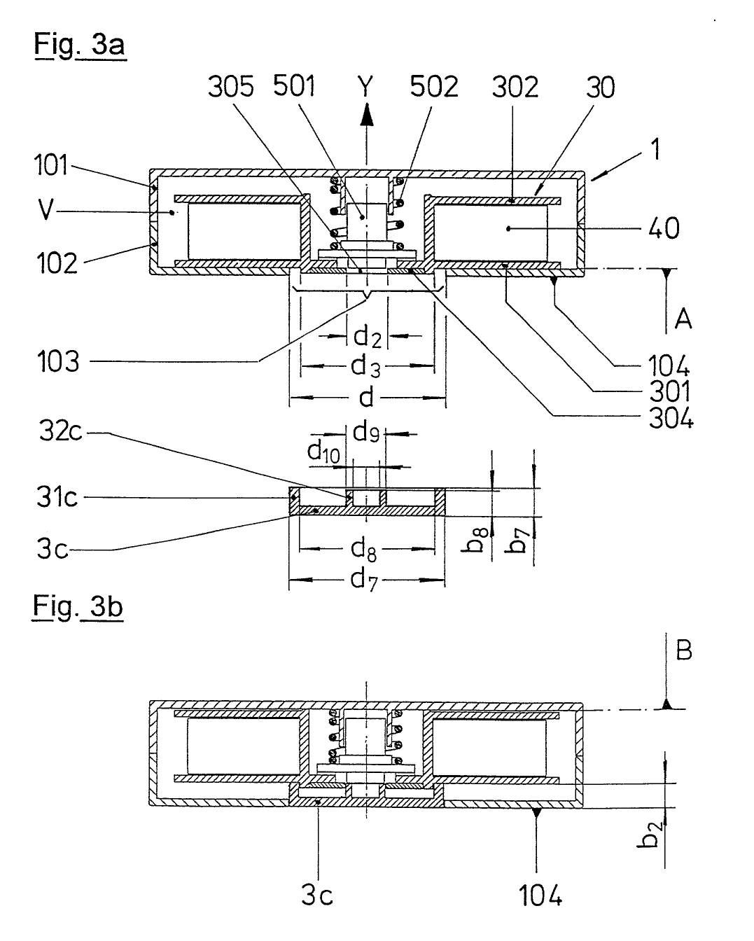

FIGS. 3a and 3b show another embodiment of the transport securing element 3c which can be inserted into the circular access opening 103 of the lower housing part 102.

According to this embodiment, the transport securing element 3c is formed as a substantially disk-shaped element which has, on a side that faces a metal plate 304 which is attached to the hub 303, annular elevations 31c, 32c formed thereon. An outside diameter d₇ of an outer annular elevation 31c is made approximately slightly smaller than a diameter “d” of the circular access opening 103. An inside diameter d₈ of the outer annular elevation 31c is made approximately slightly larger than a diameter d₃ of the tape reel hub 303 protruding into the access opening 103. An outside diameter dg of the inner annular elevation 32c is made approximately slightly smaller than the diameter d₂ of a concentric aperture 305 formed in the metal plate 304. An inside diameter d₁₀ of the inner annular elevation 32c is made freely selectable within technical production limits. A thickness b₇ of the transport securing element 3c may be substantially determined by accounting for the distance b₂ between the lower reel flange 301 when the tape reel 30 is in the upper abutting position B, i.e., when the tape reel is forced against the upper housing half 101 in the interior space V, and by accounting for the outer surface 104 which faces away from the interior space V. The thickness b₈ of the transport securing element 3c may be dimensioned in such a way that the annular elevation 32c of the transport securing element 3c cannot release the reel brake, i.e., the annular elevation 32c is not so thick b₈ so as to be able to disengage reel brake 501 from the reel hub 303.

This embodiment has the advantage of limiting the radial mobility of the tape reel 30 during transport, since it provides for the centering of the tape reel 30 within the cartridge 1 by concentrically arranging the diameters d₂ and d. Such centering is facilitated because the tolerance of the diameter d₂ is significantly less than the tolerance of the diameter d₃. Consequently, the diameter d₉ should be made with close tolerances.

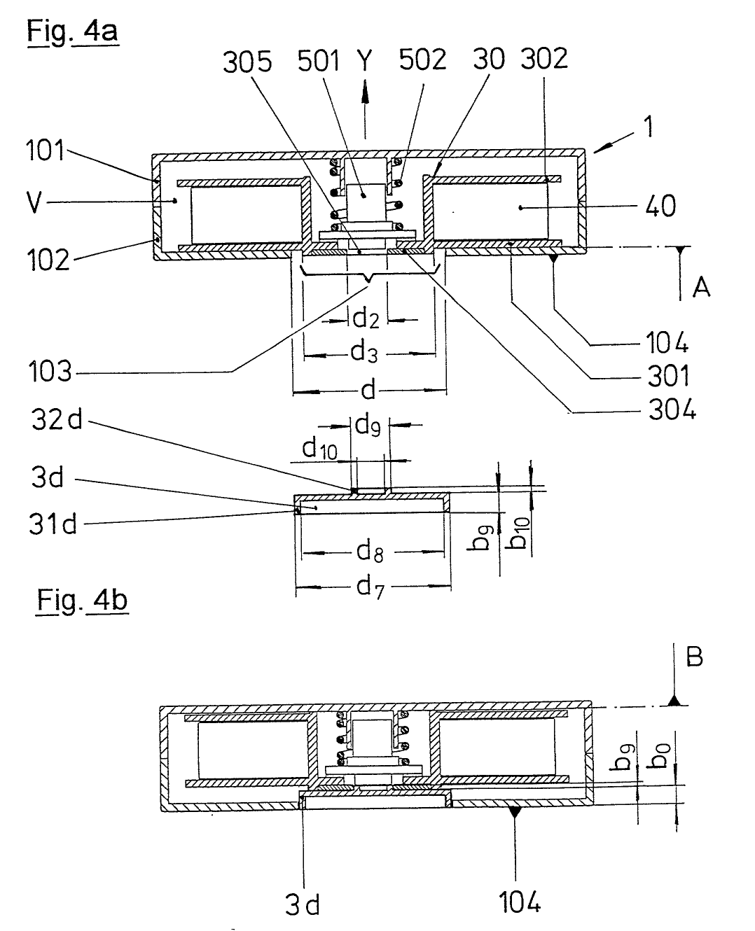

Still another embodiment is shown in FIGS. 4a and 4b. According to this embodiment, the transport securing element 3d has a circular or annular elevation 32d that is provided on an upper end face. As with the other embodiments, the transport securing element 3d is substantially disk-shaped. However, this embodiment provides for an outer downward facing annular elevation 31d, i.e, arranged on a face which is opposite the end face that faces the metal plate 304. The diameters d₇, d₈, d₉ and d₁₀ of the transport securing element 3d can be made approximately substantially identical to the embodiment represented in FIG. 3a. Additionally, the thickness b₉ can also be approximately substantially identical to the thickness b₄ of the embodiment shown in FIGS. 1a and 1b. The thickness b₁₀ of the transport securing element 3d may be made dependent on the dimensions of the reel brake 501 and may be chosen such that the reel brake 501 is not raised, i.e., the annular elevation 32d is not so thick b₁₀ so as to be able to disengage reel brake 501 from the reel hub 303.

The invention contemplates that, instead of the annular elevation 32d, a circular solid elevation (not shown) is provided on the transport securing element 3d.

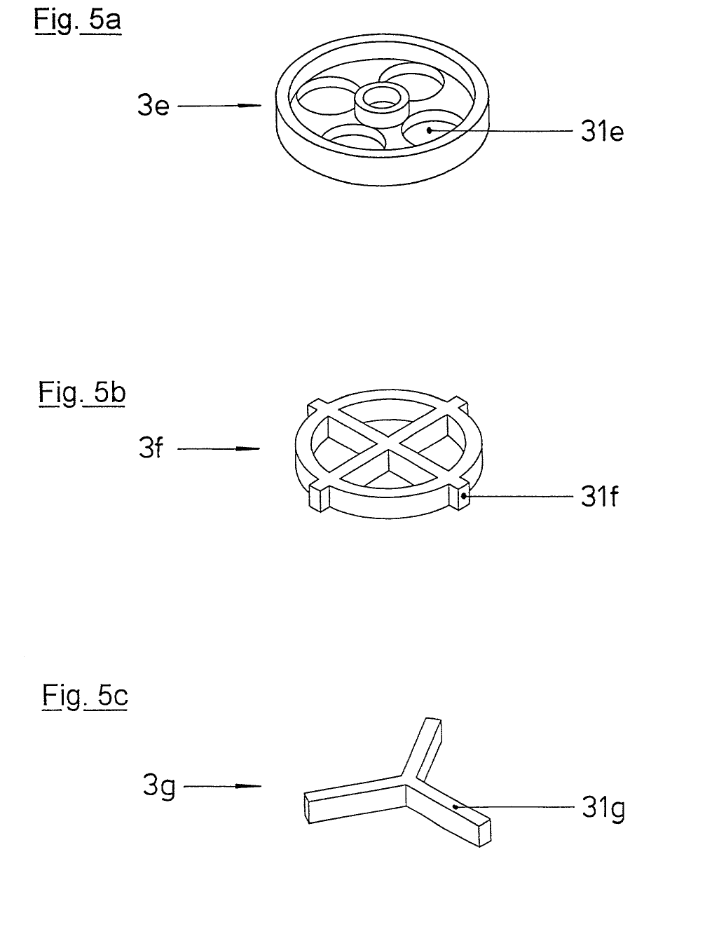

The transport securing element shown in FIGS. 1a through 4b and described above are basic forms which can be varied as desired according to technical production requirements and design aspects, without leaving the scope of the invention. Thus, as is shown, by way of example in FIG. 5a, the transport securing element 3e may correspond in basic form to the transport securing element 3c, and further include other features such as, e.g., circular clearances 31e, which can be provided to save material and/or manufacturing costs. FIGS. 5b and 5c show other material-optimized variants of the transport securing elements 3f and 3g. These transport securing elements 3f, 3g may utilize projections 31 or the ends of the legs 31g for centering in the circular access opening 103. The invention also contemplates other designs and is not limited to the number of legs shown. Thus, for example, the number of legs used in the embodiment of FIG. 5b can be as few as two and can be greater than the four legs shown. Moreover, the number of legs used in the embodiment of FIG. 5c can also be as few as two and can be greater than the three legs shown. Finally, other shapes are also contemplated by the invention wherein the transport securing element is able to easily slide in and out of the circular access opening so as to prevent the reel 30 from moving about within the cartridge 1 and be damaged thereby.

For logistical reasons, it is generally desirable to supply the end user with many cartridge in the form of large packaging units which comprise a plurality of data storage cartridges. In this regard, many transport securing elements may be used to secure the reels 30 within the cartridges 1.

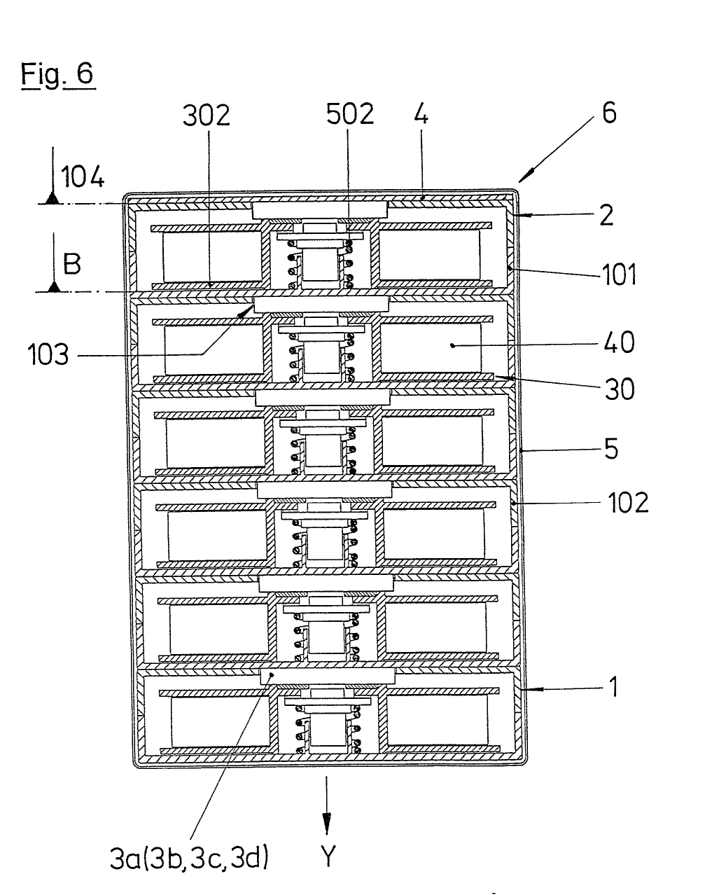

According to the embodiment shown in FIG. 6, a stack 6 of data storage cartridges, e.g., 1 and 2, forms a packaging unit. The stack 6 comprises at least two data storage cartridges 1 and 2 and as many transport securing elements or any disclosed design, e.g., 3a through 3g. These are inserted into the circular access openings 103 of each cartridge. A planar top plate 4 is placed on top of the stack 6 and a wrapping 5 is placed around the entire stack 6 to form the packaging unit.

As can be seen from FIG. 6, the data storage cartridges may be stacked one on top of the other and in the same alignment such that the access openings 103 all face a direction which is counter to an axial direction Y. However, it is also possible for the stack 6 to be arranged in such a way that the access openings 103 of each cartridge all face in the same axial direction Y (not shown). In either case, the planar top plate 4 is provided to bear against the outer surface 104 of the lower housing half 102 of an end data storage cartridge 2 so as to keep the top transport securing element from coming out of the top cartridge 2 in the stack 6, i.e, this is because the end data storage cartridge 2 is the cartridge of which the access opening 103 is not covered by an adjacent data storage cartridge. The invention contemplates that any commercially available and acceptable packaging film may be utilized, such as for example shrink films. The invention even contemplates that cardboard or other similar packaging systems may be utilized, provided the dimensions of the packaging are made to match the stack of cartridges.

It goes without saying that the stack packaging system described above can also be employed for packaging a single data storage cartridge, i.e., this may include e.g., a single cartridge, a single transport securing element 3a-3g, a cover plate 4, and wrapping 5.

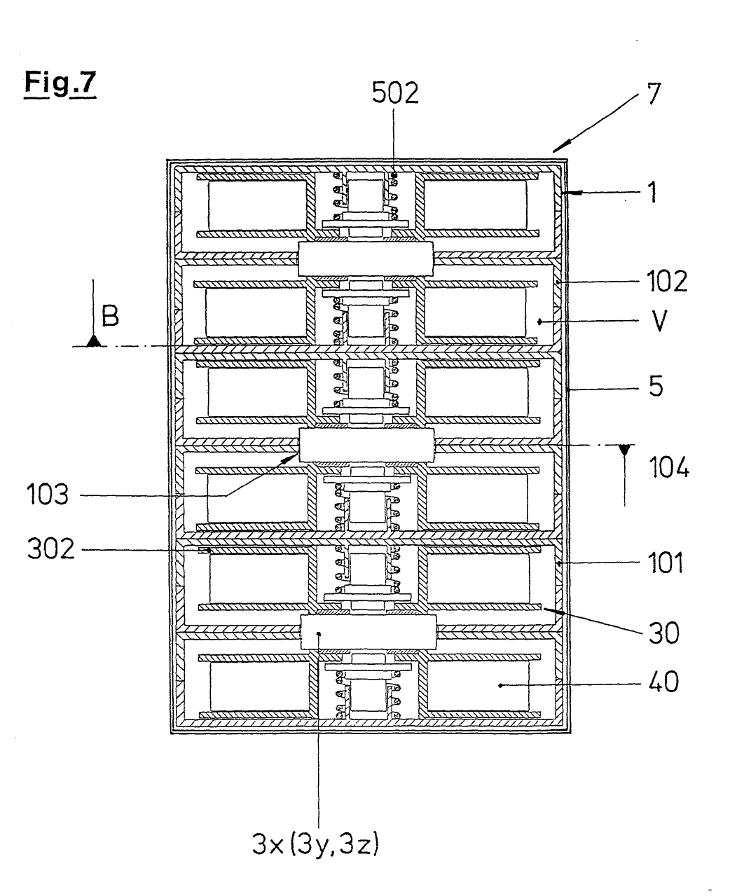

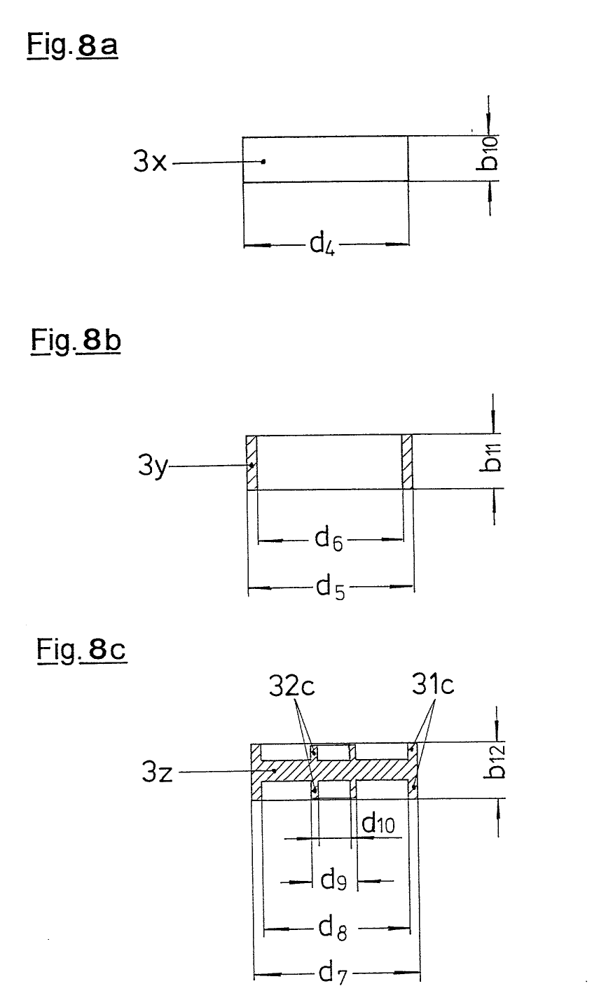

Another embodiment of a stack 7 of data storage cartridges is shown FIG. 7. This embodiment comprises at least two data storage cartridges 1 and half as many transport securing elements 3x-3z (see FIGS. 8a-8c). These are inserted into the circular access openings 103 of adjacent cartridges and a wrapping 5 is applied to the packing unit. As can be seen in FIG. 7, pairs of data storage cartridges 1 are combined to form one or more sub-double packs which are each arranged in such a way that their access openings 103 face one another. This arrangement consequently allows one transport securing element 3x, 3y or 3z, to secure the tape reels 30 of two adjacent data storage cartridges 1. This advantage of this arrangement of the data storage cartridges is that it does not require the planar top plate 4. As can be clearly seen from FIG. 7, a plurality of such double packs can be stacked one on top of the other and wrapped with wrapping 5 to form the packing unit.

The variety of transport securing elements 3x, 3y, 3z which can be used with the stack 7 shown in FIG. 7, are shown in FIGS. 8a to 8c.

As can be readily seen, the transport securing elements 3x, 3y differ from the transport securing elements 3a, 3b shown in FIGS. 1a and 2a only with regard to their height, with the height b₁₀=2×b₄ and the height b₁₁=2×b₅.

The transport securing element 3z shown in FIG. 8c corresponds to two transport securing elements of the type (i.e., 3c) shown in FIGS. 3a and 3b, which are joined to each other on the rear sides. This allows both end faces of the transport securing element 3z to have the inner and outer annular elevations 31c, 32c. In this embodiment, the height b₁₂=2×b₇.

As can be seen by a person skilled in the art, the transport securing element 3d shown in FIG. 4a can also be easily modified in such a way that it performs the function of the transport securing elements shown in FIGS. 8a-8c.

The invention also provides for various methods of securing a stack 6, 7 of data storage cartridges 1 for transport.

As shown in FIG. 6, the stack 6 of data storage cartridges 1 comprises at least two data storage cartridges 1, 2, and as many transport securing elements, e.g., 3a-3g, a planar top plate 4 and a wrapping medium 5, all of which form a packing unit. The packing unit is formed of a first data storage cartridge 1 having a transport securing element, e.g., 3a, inserted into its access opening 103. This may be done by hand or facilitated with a stacking aid (not shown). The insertion is performed in such a way that the access opening 103 provided in the lower part 102 of the housing faces counter to the axial direction Y, that is to say faces upward. Additional cartridges are then placed on top of the first cartridge 1 and each cartridge receives transport securing element with its access opening 103. The process is continued until an appropriately sized stack 6 is formed. In forming the stack, the cartridges should, of course, be positioned in aligned manner, i.e., each cartridge is placed one on top of the other in such a way that the access openings 103 receives a transport securing element before another cartridge is place over the access opening of the previously deposited cartridge. This procedure is repeated until the desired number of data storage cartridges is reached. The planar top plate 4 may then be placed onto the end data storage cartridge 2 so as to help retain the top transport securing element. This top end data storage cartridge 2 is that cartridge, of which the access opening 103 is not covered by an adjacent data storage cartridge, but is instead covered by the top plantar plate 4. The stack 6 of data media cartridges formed in this way is then pressed together by the action of an external force which acts in the opposite direction to the restoring forces of the springs 502. This causes all the upper reel flanges 302 of the tape reels 30 into the upper abutting position B, i.e., the reels 30 are all pressed against the upper housing half 101. The stack 6 of data storage cartridges under this stress is then stabilized by applying the wrapping 5. After this, the stack may be removed from the stacking aid (if one is utilized). The stack 6 of data storage cartridges assembled in this way is then ready for shipment, and should arrive at the desired location without damage being caused to the tape reels 30 or to the data recording medium 40.

When the wrapping 5 is removed, the action of the external force created by the wrapping is no longer exerted, and the tape reels 30 then return to their lower abutting position A under the action of the restoring forces of the springs 502. The transport securing elements 3a-3g should then slide out of the access openings 103 automatically. The data storage cartridges 1 are then consequently ready for use.

It goes without saying that the stack 7 of data storage cartridges 1 can also be set up in an opposite manner, i.e., with the first data storage cartridge being placed onto the planar top plate 4 such that the access opening 103 faces in the axial direction Y.

Another embodiment of the method of securing a stack 7 of data storage cartridges 1 for transport is shown in FIG. 7 and comprises arranging the cartridges in a way corresponding to FIG. 7.

The stack 7 comprises at least two data storage cartridges 1 and half as many transport securing elements, e.g., 3x, 3y or 3z, inserted into the circular access openings 103 of adjacent cartridges. Each set of adjacent cartridges are joined together to form a double pack or sub-assembly. The entire stack 7 may be formed of one or more of these double packs and then wrapped with wrapping 5.

Arranged between the two cartridges in each double pack is a transport securing element, e.g., 3x, 3y, or 3z. In assembling the stack 7, a transport securing element is inserted into a first data storage cartridge and a second data storage cartridge is placed onto the first data storage cartridge in such a way that the two circular access openings 103 face one another. A transport securing element 3x, 3y or 3z is used to secure each double pack of the tape reels 30, i.e, of two adjacent data storage cartridges 1. The invention also provides that a first double pack is deposited in a stacking aid (not shown). Thereafter, additional data storage cartridges are placed on top of the first double pack to form the stack 7. These additional double packs may be joined together in the same way as the first double pack until all the double packs are assembled in the stacking aid (not shown). Since, in this arrangement of the cartridges 1, all the access opening containing surfaces 104 face each other, the planar top plate 4 is not required. As with the method describing the formation of stack 6 of FIG. 6, the stack 7 shown in FIG. 7 may be formed with the data storage cartridges being pressed together by the action of an external force, acting in the opposite direction to the restoring forces of the springs 502, so that all the upper reel flanges 302 of the tape reels 30 can be forced into the upper abutting position B. Just as in the previous method embodiment, the stack 7 of data storage cartridges which is placed under stress, is then stabilized by applying a wrapping 5. Thereafter, the stack 7 is removed from the stacking aid (if one is used). The stack 7 of data storage cartridges 1 produced in this way is then ready for shipment without damage being caused to the tape reels 30 or to the data recording medium 40, or both.

When the wrapping 5 is removed, the action of the external force is no longer experienced and the tape reels 30 are allowed to return to their lower abutting position A under the action of the restoring forces created by the springs 502. The transport securing elements will be caused to slide automatically out of the access openings 103 by action of the springs 502 and the data storage cartridges 1 will consequently be ready for use. It should be noted that the use of the transport securing elements described herein is not restricted to data storage cartridges that have a single tape reel. The invention contemplates the use of these devices with cartridges having a plurality (two or more) of tape reels, such as is the case, for example, with video cassettes.

It should be noted that the transport securing elements 3a-3g and 3x-3z can be made of any convenient material which does not cause damage to the cartridges, the reels and the tape medium. Such materials include, but are not limited to materials such as, e.g., plastics, polymers, composites, wood, soft metals such as aluminum, as well as any other convenient materials, etc.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

What is claimed:

1. A combination of at least one transport securing element and at least one data storage cartridge, the combination comprising:
the data storage cartridge comprising a housing which includes at least one access opening, the housing enclosing at least one tape reel and at least one biased reel brake mechanism, wherein the at least one reel brake mechanism is adapted to prevent movement of the at least one tape reel; and
the transport securing element being dimensioned to slide in and out of the at least one access opening and being adapted to move the tape reel from a first position to a second position,
wherein the at least one transport securing element is free to slide out of the at least one access opening under a biasing force exerted by the reel brake mechanism when a force opposing the biasing force is removed.

2. The combination of claim 1, wherein the at least one transport securing element is free to move in and out of the at least one access opening without being non-movably retained by the housing.

3. The combination of claim 1, wherein the housing comprises at least two parts which are one of releasably and non-releasably attached to one another.

4. The combination of claim 1, wherein the at least one transport securing element is one of substantially disk-shaped and substantially circular.

5. The combination of claim 1, wherein the at least one transport securing element comprises at least two legs.

6. The combination of claim 1, wherein the at least one access opening is substantially circular.

7. The combination of claim 1, wherein the at least one tape reel comprises a reel hub portion and at least two flange portions.

8. The combination of claim 1, wherein the at least one tape reel comprises a portion which at least partially protrudes into the at least one access opening.

9. The combination of claim 1, wherein the second position comprises a position wherein the at least one tape reel is positioned against a side of the housing which is opposite to a side of the housing which has the at least one access opening.

10. The combination of claim 1, wherein the tape reel comprises a hub which protrudes into the at least one access opening, the hub including a mechanism for coupling the at least one tape reel to a drive hub.

11. The combination of claim 1, wherein the at least one tape reel is movable when the at least one reel brake mechanism is disengaged from the at least one tape reel.

12. The combination of claim 1, wherein the at least one transport securing element is substantially in the shape of a hollow-cylinder.

13. The combination of claim 1, wherein the at least one transport securing element comprises a thickness, which when added to a thickness of the at least one tape reel, is substantially approximately equal to a width of a space within the housing plus a thickness of a side wall which contains the at least one access opening.

14. The combination of claim 1, wherein the at least one transport securing element comprises a thickness, which when added to a thickness of the at least one tape reel measured on one side of the tape reel and a flange on another side of the tape reel, is substantially approximately equal to a width of a space within the housing plus a thickness of a side wall which contains the at least one access opening.

15. The combination of claim 1, wherein the at least one transport securing element comprises a thickness, which when added to a thickness of the at least one tape reel measured on one side of the tape reel and a flange on another side of the tape reel, is substantially approximately equal to twice a width of a space within the housing plus a thickness of a side wall which contains the at least one access opening.

16. The combination of claim 1, wherein the at least one transport securing element comprises a thickness, which when added to a thickness of the at least one tape reel, is substantially approximately equal to twice a width of a space within the housing plus a thickness of a side wall which contains the at least one access opening.

17. The combination of claim 1, wherein the at least one transport securing element comprises at least one of a circular elevation and an annular elevation.

18. The combination of claim 17, wherein at least one of the circular or annular elevations is arranged on a side of the transport securing element which engages the at least one tape reel.

19. The combination of claim 18, wherein at least one of the circular or annular elevations is arranged on a side of the transport securing element which is opposite a side that engages the at least one tape reel.

20. The combination of claim 17, wherein at least another of the circular or annular elevations is arranged on a side of the transport securing element which is opposite a side that engages the at least one tape reel.

21. A combination of at least one transport securing element and at least one data storage cartridge, the combination comprising:
the data storage cartridge comprising a housing which includes at least one access opening, the housing enclosing at least one tape reel and at least one biased reel brake mechanism, wherein the at least one reel brake mechanism is adapted to prevent movement of the at least one tape reel; and
the transport securing element being dimensioned to slide in and out of the at least one access opening and being adapted to move the tape reel from a first position to a second position,
wherein the at least one transport securing element is free to slide out of the at least one access opening under a biasing force exerted by the reel brake mechanism when a force opposing the biasing force is removed, and
wherein the at least one cartridge is wrapped with a material.

22. The combination of claim 21, wherein the at least one cartridge comprises at least two cartridges and at least two transport securing elements, each of the transport securing elements being free to slide out of the at least one access opening under a biasing force exerted by the reel brake mechanism when a force opposing the biasing force is removed.

23. The combination of claim 21, wherein the at least one cartridge comprises at least two cartridges arranged with their at least one access openings facing one another, the at least one transport securing element being free to slide out of both access openings of adjacent cartridges under a biasing force exerted by the reel brake mechanisms when a force opposing the biasing force is removed.

23. The combination of claim 21, wherein the at least one cartridge comprises a stack of cartridges.

24. The combination of claim 21, further comprising a plate for preventing the removal of the at least one of the transport securing element.

25. The combination of claim 24, wherein the wrapping covers the plate and the at least one cartridge.

26. A method combining at least one transport securing element and at least one data storage cartridge, the method comprising:
providing the data storage cartridge comprising a housing which includes at least one access opening, the housing enclosing at least one tape reel and at least one biased reel brake mechanism, wherein the at least one reel brake mechanism is adapted to prevent movement of the at least one tape reel;
installing the at least one transport securing element into the at least one access opening, the transport securing element being dimensioned to slide in and out of the at least one access opening and being adapted to move the tape reel from a first position to a second position, wherein the at least one transport securing element is free to slide out of the at least one access opening under a biasing force exerted by the reel brake mechanism when a force opposing the biasing force is removed; and
wrapping the at least one cartridge with a material.

27. The method of claim 26, wherein the at least one cartridge comprises at least two cartridges and at least two transport securing elements, each of the transport securing elements being free to slide out of the at least one access opening under a biasing force exerted by the reel brake mechanism when a force opposing the biasing force is removed.

28. The method of claim 26, wherein the at least one cartridge comprises at least two cartridges arranged with their at least one access openings facing one another, the at least one transport securing element being free to slide out of both access openings of adjacent cartridges under a biasing force exerted by the reel brake mechanisms when a force opposing the biasing force is removed.

29. The method of claim 26, further comprising forming a stack of cartridges.

30. The method of claim 29, further comprising installing a plate at one end of the stack for preventing the removal of the at least one of the transport securing element.

31. The method of claim 30, wherein the wrapping covers the plate and the at least one cartridge.
